(19) United States
(12) Patent Application Publication
(10) Pub. No.: US 2008/0173188 A1
(43) Pub. Date: Jul. 24, 2008

(54) Hot dog cooker

(76) Inventor: Huaguo Lu, Ningbo (CN)

Correspondence Address: Canghui Song;PMB 601, 1750-1, 30th Street, Boulder, CO, 80301, US

(21) Appl. No.: 11/655,990

(22) Filed: Jan. 22, 2007

(51) Int. Cl. A47J 37/04; A47J 37/00; A47J 43/00

(52) U.S. Cl. 99/441; 99/443 R; 219/388

(57) ABSTRACT

A hot dog cooker has a rotatable sausage rack received in a space between two supporting housings installed on a base housing mounted on a chases. The sausage rack has a pair of round end plates respectively mounted on the supporting housing, a plurality of transversal poles evenly installed on peripherals of the two round end plates, and a set of hanging means including at least two spaced placed identical hooks on each transversal poles. Each hooks has a ring end loosely surrounding the transversal pole and a curved end suspending downward for supporting a sausage thereon. Each curved end of the hooks has a mouth via which the sausage is able to be put in and take out. The hot dog cooker is able to cook more pieces of sausages at the same time without significantly increase volume and weight thereof.

### BACKGROUND OF THE INVENTION

1. Field of the Invention

The invention relates to a hot dog cooker, more particularly, to a compact hot dog cooker which is able to heat more sausages at the same time in a relatively small volume.

2. Description of the Prior Art

Shown in FIG. 1 is a traditional hot dog maker. The hot god maker 9 has a framing body 91 supporting a plurality of, usually 5, electric heating rollers 92 rotatably mounted thereon, a plurality of, usually 2, bread supporting poles 93 securely mounted thereon, a timer, and a work light. One or more pieces of sausages 94 are able to be supported on between each two electric heating rollers 92 for baking. One or more pieces of hollowed elongated bread 95 are able to be supported on the bread supporting poles 93.

Such hot dog maker has some drawbacks. The electric heating rollers 92 must be placed side by side at one level in order for convenience of putting and taking the sausages 94. When more pieces of sausages, usually more than 4, need to be cooked at the same time, more electric heating rollers 92 have to be added correspondingly, which will significantly increase volume and weight of the hot dog maker.

### BRIEF SUMMARY OF THE INVENTION

The main object of the invention is to provide a hot dog cooker which is able to cook more pieces of sausages at the same time without significantly increase volume thereof.

The main object of the invention is to provide a hot dog cooker which is able to cook more pieces of sausages at the same time without significantly increase weight thereof.

In order to accomplish the above objects, the present invention provides a hot dog cooker having:

a chaises;

a base housing detachably mounted on the chaises;

a first supporting housing securely mounted on one side of the base housing;

a second supporting housing securely mounted on an opposite side of the base housing, leaving a space between the first and the second supporting housing;

a motor installed in the first supporting housing;

a sausage rack being received in the space between the first and the second supporting housing, having a pair of round end plates respectively and rotatably mounted on the first and the second supporting housing, a plurality of transversal poles evenly installed on peripherals of the two round end plates, and a set of hanging means including at least two spaced placed identical hooks on each the transversal poles, each the hooks having a ring end loosely surrounding the transversal pole and a curved end suspending downward for supporting a sausage thereon, each the curved end having a mouth, a hole being defined in each the round end plate through which the electric heating tube is able to pass and be fixed to the first and the second supporting housing, respectively;

an electric heating tube transversally passing the sausage rack with two ends thereof respectively fixed on the first and the second supporting housing and when electrified, is able to give heat;

a transitional means contained being able to make the sausage rack drivenable to rotate by the motor;

a timer to adjust the time of heating;

a power source electrically connected to and supplying power for the motor, the timer, and the electric heating tube; and,

a cooker cover covering on the first supporting housing, the second supporting housing, and the sausage rack and defining a basically air tight space surrounding the sausage rack.

These and other objectives, features, and advantages of the present invention will become apparent from the following detailed description, the accompanying drawings, and the appended claims.

### BRIEF DESCRIPTION OF THE DRAWINGS

FIG. 1 is a schematic perspective view of a traditional hot dog maker.

FIG. 2 is a schematic perspective view of the hot dog cooker of the invention with the cooker cover thereof closed.

FIG. 3 is a schematic perspective view of the hot dog cooker of the invention shown in FIG. 2 with the cooker cover thereof removed. And,

FIG. 4 is a schematic perspective exploded view of the hot dog cooker shown in FIG. 2.

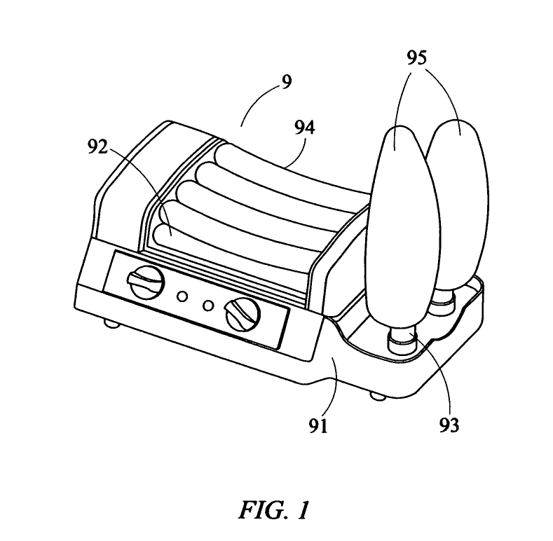

### DETAILED DESCRIPTION OF THE PREFERRED EMBODIMENT

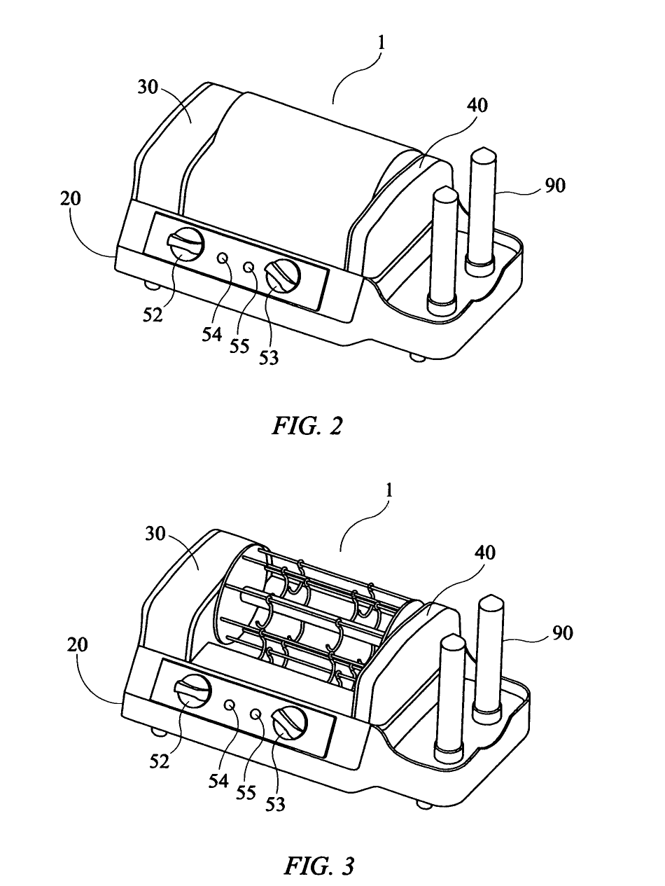

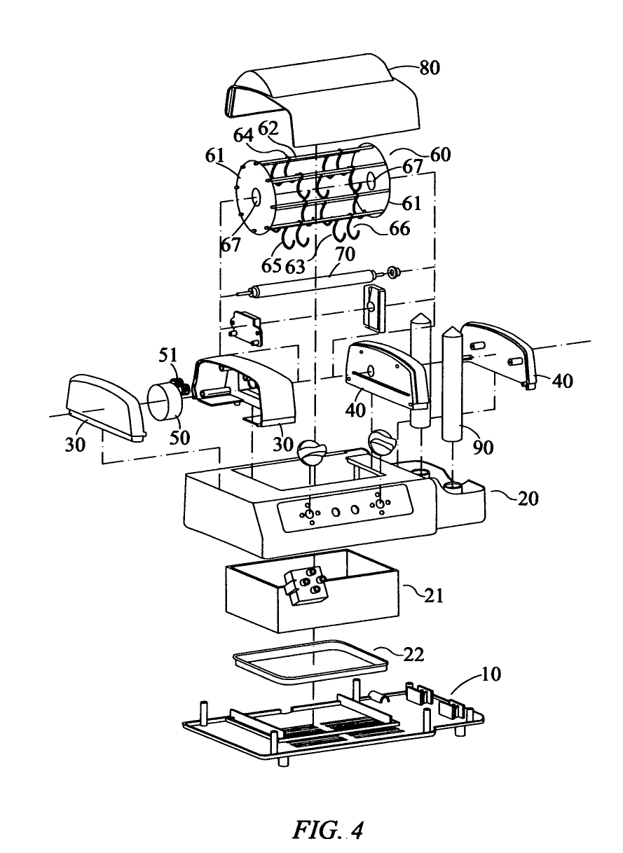

With reference to FIGS. 2, 3 and 4, a preferred embodiment of a hot dog cooker 1 of the invention is shown. The hot dog cooker 1 has a chaises 10, a base housing 20 detachably mounted on the chaises 10, a first supporting housing 30 securely mounted on one side of the base housing 20, a second supporting housing 40 securely mounted on an opposite side of the base housing 20, leaving a space between the first and the second supporting housing 30 and 40, a motor 50 installed in the first supporting housing 30, a sausage rack 60 being received in the space between the first and the second supporting housing 30 and 40, an electric heating tube 70 transversally passing the sausage rack 60 with two ends thereof respectively fixed on the first and the second supporting housing 30 and 40 and when electrified, is able to give heat to bake sausages (not shown in the FIGs.), a transitional means 51, such as a set of gears, contained in the first supporting housing 30 and making the sausage rack 60 drivenable to rotate by the motor 50, a timer 52 used to adjust the time of heating, a power source (not shown) electrically connected to and supplying power for the motor 50, the timer 52, and the electric heating tube 70, and a cooker cover 80 covering on the first supporting housing 30, the second supporting housing 40, and the sausage rack 70 and defining a basically air tight space surrounding the sausage rack 70.

The sausage rack 60 has a pair of round end plates 61 respectively and rotatably mounted on the first and the second supporting housing 30 and 40, a plurality of, preferably 8, transversal poles 62 evenly installed on peripherals of the two round end plates 61, and a set of hanging means including at least two spaced placed identical hooks 63 on each transversal poles 62. Each of the hooks 63 has a ring end 64 loosely surrounding the transversal pole 62 and a curved end 65 suspending downward for supporting a sausage thereon. Each curved end 65 of the hooks 63 has a mouth 66 via which the sausage is able to be put in and take out. A hole 66 is defined in each round end plate 61 through which the electric heating tube 70 is able to pass and be fixed to the first and the second supporting housing 30 and 40, respectively.

The hot dog cooker 1 of the invention may also has a heat intensity adjuster 53, a work light 54 which is able to indicate a situation of working, or a number of, preferably 2, bread supporting poles 90 mounted on the chases 10. An oil collecting plate 22 and an oil shielding sleeve 21 are able to be provided within the base housing 20. A separate power light 55 from the work light 54 is preferred which enable a user to know whether power is well in condition before he starts the timer 52.

In use, a user is able to place the hot dog cooker 1 of the invention on a level and plane surface and then electrify it. When sausages are prepared, the user is able to open the cooker cover 80 and rotate the sausage rack 60 with one hand to a position at which a sausage is convenient to be put into the hooks 63 of each hanging means via the mouths 66 thereof and then put the sausage in with another hand. The user is able to continue to rotate the sausage rack 60 and put other sausages in until all the hanging means of the sausage rack 60 is filled with sausage and then close the cooker cover 80. The user is then able to start the hot dog cooker 1 by adjusting the timer 52 to a preferred time. The electric heating tube 70 starts to give heat and the sausage rack 60 starts to rotate, baking the sausages within the basically air tight space. When the preferred time expired, the user is able to open the cooker cover 80 again and rotate the sausage rack 60 with one hand to a position at which a baked sausage is convenient to be taken out from each hanging means via the mouths 66 thereof and then take it out with another hand. The user is able to continue to rotate the sausage rack 60 and take other baked sausages out.

According to the hot dog cooker 1 of the invention, more pieces of sausages are able to by baked at the same time without increase number of electric heating rollers, which have to be placed side by side at a level plane, thus keeping volume and weight of the hot dog cooker 1 of the invention not significantly increased.

It will thus be seen that the objects of the present invention have been fully and effectively accomplished. Its embodiments have been shown and described for the purposes of illustrating the functional and structural principles of the present invention and is subject to change without departure from such principles. One skilled in the art will understand that the embodiment of the present invention as shown in the drawings and described above is exemplary only and not intended to be limiting. Therefore, this invention includes all modifications encompassed within the spirit and scope of the following claims.

What is claimed is:

1. A hot dog cooker comprising:
a chaises;
a base housing detachably mounted on said chaises;
a first supporting housing securely mounted on one side of said base housing;
a second supporting housing securely mounted on an opposite side of said base housing, leaving a space between said first and said second supporting housing;
a motor installed in said first supporting housing;
a sausage rack being received in said space between said first and said second supporting housing, having a pair of round end plates respectively and rotatably mounted on said first and said second supporting housing, a plurality of transversal poles evenly installed on peripherals of said two round end plates, and a set of hanging means including at least two spaced placed identical hooks on each said transversal poles, each said hooks having a ring end loosely surrounding said transversal pole and a curved end suspending downward for supporting a sausage thereon, each said curved end having a mouth, a hole being defined in each said round end plate through which said electric heating tube is able to pass and be fixed to said first and said second supporting housing, respectively;
an electric heating tube transversally passing said sausage rack with two ends thereof respectively fixed on said first and the second supporting housing and when electrified, is able to give heat;
a transitional means contained being able to make said sausage rack drivenable to rotate by said motor;
a timer to adjust the time of heating;
a power source electrically connected to and supplying power for said motor, said timer, and said electric heating tube; and,
a cooker cover covering on said first supporting housing, said second supporting housing, and said sausage rack and defining a basically air tight space surrounding said sausage rack.

2. The hot dog cooker as claimed in claim 1, wherein the number of said transversal pole is 8.

3. The hot dog cooker as claimed in claim 1, wherein the hot dog cooker further has a number of bread supporting pole mounted on said chases.

4. The hot dog cooker as claimed in claim 3, wherein the number of said supporting pole is 2.

5. The hot dog cooker as claimed in claim 1, wherein said hot dog cooker further has a power light.

6. The hot dog cooker as claimed in claim 2, wherein said hot dog cooker further has a power light.

7. The hot dog cooker as claimed in claim 4, wherein said hot dog cooker further has a power light.

8. The hot dog cooker as claimed in claim 1, wherein said hot dog cooker further has a heat intensity adjuster.

9. The hot dog cooker as claimed in claim 2, wherein said hot dog cooker further has a heat intensity adjuster.

10. The hot dog cooker as claimed in claim 4, wherein said hot dog cooker further has a heat intensity adjuster.

11. The hot dog cooker as claimed in claim 5, wherein said hot dog cooker further has a heat intensity adjuster.

12. The hot dog cooker as claimed in claim 6, wherein said hot dog cooker further has a heat intensity adjuster.

13. The hot dog cooker as claimed in claim 7, wherein said hot dog cooker further has a heat intensity adjuster.

14. The hot dog cooker as claimed in claim 2, wherein said hot dog cooker further has a work light which is able to indicate a situation of working.

15. The hot dog cooker as claimed in claim 4, wherein said hot dog cooker further has a work light which is able to indicate a situation of working.

16. The hot dog cooker as claimed in claim 5, wherein said hot dog cooker further has a work light which is able to indicate a situation of working.

17. The hot dog cooker as claimed in claim 6, wherein said hot dog cooker further has a work light which is able to indicate a situation of working.

18. The hot dog cooker as claimed in claim 11, wherein said hot dog cooker further has a work light which is able to indicate a situation of working.

19. The hot dog cooker as claimed in claim 12, wherein said hot dog cooker further has a work light which is able to indicate a situation of working.

20. The hot dog cooker as claimed in claim 13, wherein said hot dog cooker further has a work light which is able to indicate a situation of working.
